(19) United States
(12) Patent Application Publication
(10) Pub. No.: US 2026/0054437 A1
(43) Pub. Date: Feb. 26, 2026

(54) INJECTION MOLDING MACHINE

(71) Applicant: Sodick Co., Ltd., Kanagawa (JP)

(72) Inventors: Shingo Taniguchi, Kanagawa (JP); Yasuhiro KITAMURA, Kanagawa (JP); Yusuke YAMAZAKI, Kanagawa (JP); Tadashi MORIKAWA, Kanagawa (JP)

(73) Assignee: Sodick Co., Ltd., Kanagawa (JP)

(21) Appl. No.: 19/230,108

(22) Filed: Jun. 6, 2025

(30) Foreign Application Priority Data
Aug. 22, 2024 (JP) 2024-140582

(51) Int. Cl. B29C 45/58; B29C 45/17; B29C 45/54; B29C 45/74

(52) U.S. Cl. CPC B29C 45/586; B29C 45/1775; B29C 45/54; B29C 45/74

(57) ABSTRACT

An injection device of an injection molding machine includes an injection cylinder, a plunger, and a seal cylinder. The seal cylinder has a seal surface facing the plunger, a front surface forming a front surface flow path, and an outer side surface forming a side surface flow path. Between the injection cylinder and a side surface of the plunger, a first clearance is provided which is a gap that allows a molding material to flow through. Between the seal surface and the side surface of the plunger, a second clearance is provided which is a gap smaller than the first clearance and is reducible by a pressure of the molding material generated during dwelling.

### CROSS-REFERENCE TO RELATED APPLICATION

This application claims the priority benefit of Japanese application serial No. 2024-140582, filed on Aug. 22, 2024. The entirety of the above-mentioned patent application is hereby incorporated by reference herein and made a part of this specification.

### TECHNICAL FIELD

The disclosure relates to an injection molding machine. In particular, the disclosure relates to a screw preplasticating type injection molding machine.

### RELATED ART

An injection molding machine plasticizes a molding material, meters a predetermined amount, and injects the molding material into a mold to form a desired molded product. Injection molding machines currently in practical use are mainly classified into in-line screw type and screw preplasticating type.

A screw preplasticating type injection molding machine includes a plasticization cylinder, a screw rotatably provided in the plasticization cylinder, an injection cylinder, and a plunger provided to be advanceable and retractable in the injection cylinder. The screw rotates in the plasticization cylinder, and the molding material is plasticized and sent to the injection cylinder. Then, the plunger in the injection cylinder retracts to meter the molding material, and after metering, the plunger advances to inject the molding material. Even after the molding material is filled in a cavity of the mold, a force in the forward direction is applied to the plunger for a while. This applies a predetermined pressure to the molding material for a predetermined time. This process is called dwelling or pressure keeping.

In order to suppress galling, a certain clearance needs to be provided between the side surface of the plunger and the inner surface of the injection cylinder. The plasticized molding material may slightly leak from the rear of the injection cylinder through the gap between the plunger and the injection cylinder. If the leakage amount of the molding material is large or varies, the stability of molding is impaired. Therefore, normally, the clearance is made as small as possible to reduce the leakage amount and keep the leakage amount constant, thereby achieving stable molding.

On the other hand, if the clearance between the plunger and the injection cylinder is too small, some molding materials may not be molded properly, or component wear may become severe.

For example, in a case of using a molding material mixed with fillers, especially a molding material mixed with fillers made of metal such as MIM material, fillers that have entered the clearance may be pressed against the plunger or the injection cylinder and adhere to various parts. In addition, if the clearance is small, contact between the plunger and the injection cylinder becomes more likely to occur. In particular, when using a material that generates corrosive gas during plasticization, the surface hardness of the plunger and the injection cylinder may decrease because of corrosion. When the plunger and the injection cylinder with decreased surface hardness come into contact with each other, a part of the steel material constituting the plunger or the injection cylinder may dissolve into the molding material.

Japanese Patent No. 7121182 discloses an injection molding machine that suppresses leakage of the molding material by providing a large clearance between the plunger and the injection cylinder, while solidifying or increasing the viscosity of the molding material at the rear end of the injection cylinder.

There is a demand for achieving both the suppression of molding material leakage and the suppression of contact between the plunger and the injection cylinder more effectively with a simpler configuration.

The disclosure provides an injection molding machine that can provide a relatively large clearance between the injection cylinder and the plunger while achieving both the suppression of molding material leakage and the suppression of contact between the plunger and the injection cylinder.

### SUMMARY

According to an embodiment of the disclosure, an injection molding machine is provided that includes: a plasticization device to which a molding material including at least resin is supplied and which plasticizes the molding material; an injection device which meters and injects the molding material sent from the plasticization device and performs dwelling to apply a predetermined pressure to the molding material for a predetermined time; and a junction which connects the plasticization device and the injection device, in which the plasticization device includes: a plasticization cylinder to which the molding material is supplied; and a screw which is rotatably provided in the plasticization cylinder, in which the injection device includes: an injection cylinder to which the molding material is sent from the plasticization cylinder; a plunger which is provided to be advanceable and retractable in the injection cylinder; and a seal cylinder which is provided at a rear end of the injection cylinder and through which the plunger is inserted, in which the seal cylinder includes a seal part which seals between the injection cylinder and the plunger, in which the seal part includes: a seal surface which faces the plunger; a front surface which forms a front surface flow path that is a gap which allows the molding material to flow through between the injection cylinder and the front surface; and an outer side surface which forms a side surface flow path that is a gap which allows the molding material to flow through between the injection cylinder and the outer side surface, in which a first clearance that is a gap which allows the molding material to flow through is provided between the injection cylinder and a side surface of the plunger, and a second clearance that is a gap smaller than the first clearance and is reducible by pressure of the molding material generated during dwelling is provided between the seal surface and the side surface of the plunger.

In the injection molding machine according to the disclosure, the seal cylinder having the seal part is provided at the rear end of the injection cylinder. The second clearance between the plunger and the seal part is set to be relatively small compared to the first clearance between the plunger and the injection cylinder, and the second clearance is configured to be further reducible by the pressure of the molding material during dwelling. Thus, even if the first clearance is set relatively large, the space between the injection cylinder and the plunger is sealed by the seal cylinder, so the leakage of the molding material is suitably suppressed.

### BRIEF DESCRIPTION OF THE DRAWINGS

FIG. 1 is a schematic configuration view of the injection unit of the injection molding machine according to this embodiment.

FIG. 2 is a cross-sectional view of the injection device.

FIG. 3 is a front perspective view of the seal cylinder.

FIG. 4 is a front view of the seal cylinder.

FIG. 5 is a rear view of the seal cylinder.

FIG. 6 is a cross-sectional view of the seal cylinder.

FIG. 7 is an enlarged view of the area around the seal part.

FIG. 8 is a rear perspective view of the sub-guide cylinder.

FIG. 9 is a rear view of the sub-guide cylinder.

FIG. 10 is a cross-sectional view of the sub-guide cylinder.

### DESCRIPTION OF THE EMBODIMENTS

First, the molding material used in the injection molding machine of this embodiment will be described. A molding material containing at least resin can be widely used as the molding material. The disclosure is particularly suitable in a case where a molding material containing resin and a filler is used. In particular, the disclosure is more suitable when the filler is made of a material that has high affinity with the steel material of the injection cylinder 41 and the plunger 42. The material that has high affinity with the steel material of the injection cylinder 41 and the plunger 42 refers to, for example metal, more specifically stainless steel, nickel chromium alloy, titanium. In addition, the disclosure is suitable in a case where a molding material that generates corrosive gas during plasticization is used.

The material containing resin and a metal filler includes, for example, a MIM (Metal Injection Molding) material and a plastic magnet material. The MIM material is a type of material used for powder injection molding, and is a molding material formed by mixing metal powder as a filler and resin as a binder. The plastic magnet material is a molding material formed by mixing magnetic metal powder as a filler and resin as a binder. The filler may be in powder form or in fiber form.

Examples of the molding material that is likely to generate corrosive gas during plasticization include materials that generate corrosive gas from the resin itself and materials to which flame retardants have been added. The materials that generate corrosive gas from the resin itself are, for example, fluororesin and polyvinyl chloride. The materials to which flame retardants are often added are, for example, acrylonitrile butadiene styrene, polystyrene, polypropylene, polyethylene, polycarbonate, polycarbonate-acrylonitrile butadiene styrene alloy, modified polyphenylene ether, olefin-based thermoplastic elastomer, polyamide (including aliphatic polyamide, semi-aromatic polyamide, aromatic polyamide), polybutylene terephthalate, and saturated polyester (including polyethylene terephthalate).

The embodiments of the disclosure will be described below using the figures. The various modification examples described below may be implemented in any combination. In the figures, connecting members such as bolts connecting the parts and positioning members such as positioning pins are appropriately omitted. Also, the value of the size of each clearance described below is, unless otherwise specified, a value at room temperature (that is, about 5° C. or more and about 35° C. or less).

The injection molding machine of this embodiment is a screw preplasticating type injection molding machine. The injection molding machine includes an injection unit 1, a clamping unit (not shown), and a controller (not shown) that controls the injection unit 1 and the clamping unit. The injection unit 1 plasticizes the molding material, meters a predetermined amount, then injects the molding material into a mold (not shown) held by the clamping unit, and performs dwelling to apply a predetermined pressure to the molding material for a predetermined time. Since the molding material filled in the mold undergoes thermal shrinkage, an additional molding material is sent into the mold by the dwelling to compensate for the deficiency. The clamping unit is configured to be capable of opening and closing, and clamping the mold. During injection and dwelling, the clamping unit closes the mold and applies a clamping force at a predetermined pressure to the mold. After the molding material injected into the cavity of the mold is cooled and becomes a molded product, the clamping unit opens the mold to discharge the molded product, and closes the mold again. Well-known configurations such as direct pressure type and toggle type can be adopted as the clamping unit.

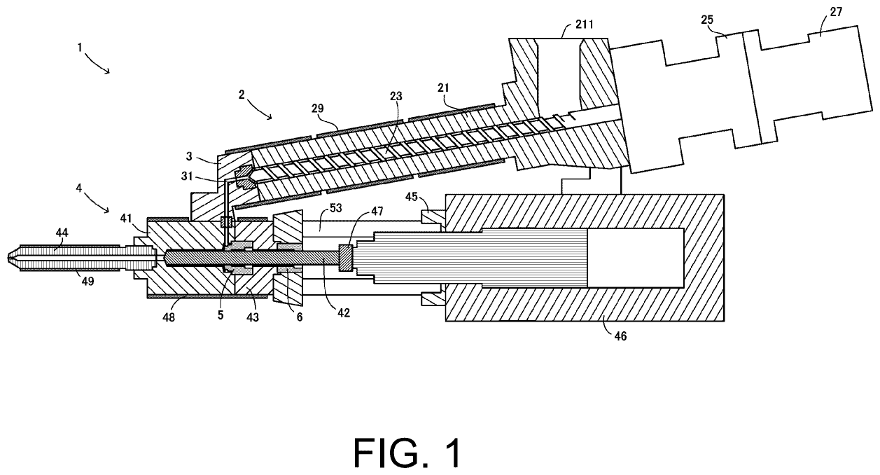

As shown in FIG. 1, the injection unit 1 includes a plasticization device 2, a junction 3, and an injection device 4. In FIG. 1, a part of the configuration is shown as a cross-sectional view. Unless otherwise specified below, the side where the molding material is injected (the left side in FIG. 1) will be described as “front,” the side where the molding material is fed (the right side in FIG. 1) as “rear,” the side where the plasticization device 2 is provided (the upper side in FIG. 1) as “upper,” and the side where the injection device 4 is provided (the lower side in FIG. 1) as “lower.” Besides, although a horizontal injection molding machine is described as an example below, the injection molding machine may be in other forms such as a vertical injection molding machine.

The plasticization device 2 plasticizes the supplied molding material and sends the molding material forward. The plasticization device 2 includes a plasticization cylinder 21, a screw 23, a backflow prevention device 25, a screw drive device 27, and a heater 29.

The plasticization cylinder 21 is a cylinder body to which the molding material is supplied. A material inlet 211 is formed on the rear side of the plasticization cylinder 21, and the molding material is fed to the material inlet 211 via a hopper (not shown) or the like. The plasticization cylinder 21 is heated to a predetermined temperature by the heater 29.

The screw 23 is rotatably provided in the plasticization cylinder 21. The screw 23 plasticizes the molding material supplied to the plasticization cylinder 21 by heat from the heater 29 and shear heat, while sending the molding material forward.

The backflow prevention device 25 is, for example, a single-acting cylinder, and advances the screw 23 to block the flow path at the time of completion of metering, and prevents backflow of the molding material during injection. Other backflow prevention mechanisms such as a ball valve may be provided instead of the backflow prevention device 25.

The screw drive device 27 may be any actuator that rotates the screw 23, for example, a hydraulic motor or an electric motor.

The junction 3 connects the plasticization device 2 and the injection device 4. The molding material sent from the plasticization cylinder 21 passes through a communication passage 31 in the junction 3 and is sent to the injection cylinder 41. A heater may be provided in the junction 3 to configure the junction to be heatable.

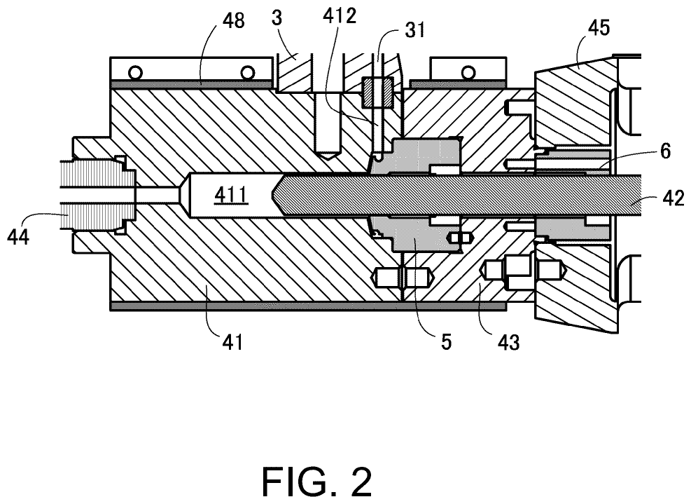

The injection device 4 meters the molding material sent from the plasticization device 2 and injects the molding material into the mold. Further, the injection device 4 performs dwelling following injection to continuously press the molding material remaining in the injection device 4 at a predetermined pressure. As shown in FIG. 1 and FIG. 2, the injection device 4 includes an injection cylinder 41, a plunger 42, a seal cylinder 5, a sub-guide cylinder 6, a connecting cylinder 43, a nozzle 44, a connecting member 45, a plunger drive device 46, a coupling 47, and heaters 48 and 49.

The injection cylinder 41 is a cylinder body that meters the molding material sent from the plasticization cylinder 21. A metering chamber 411 of the injection cylinder 41 is an inner hole through which the plunger 42 is inserted, and a desired amount of molding material is metered in the metering chamber 411. In this embodiment, a supply flow path 412 is formed on the rear side of the injection cylinder 41, and the supply flow path 412 is connected to the communication passage 31 of the junction 3. The injection cylinder 41 is heated to a predetermined temperature by the heater 48.

A first clearance C1, which is a gap through which the molding material can flow, is formed between the inner surface of the injection cylinder 41 and the side surface of the plunger 42. The molding material supplied from the supply flow path 412 is sent to the side surface of the plunger 42 via the seal cylinder 5, and sent to the front surface of the plunger 42 through the first clearance C1. Since the first clearance C1 also serves as a flow path when metering the molding material, it is preferable that the first clearance C1 be sufficiently large. In addition, the first clearance C1 is preferably sufficiently large to suppress filler adhesion and contact between the plunger 42 and the injection cylinder 41. On the other hand, the larger the first clearance C1, the greater the amount of molding material stagnating in the injection cylinder 41 and the pressure loss during injection. The size of the first clearance is, for example, about 0.5 mm or more and about 1.5 mm or less, and more preferably, about 0.9 mm or more and about 1.1 mm or less. In this embodiment, the size of the first clearance is about 1 mm.

The plunger 42 is a substantially cylindrical member that is provided to be advanceable and retractable in the injection cylinder 41. However, the tip of the plunger 42 may have a substantially conical shape. The first clearance C1 is provided as a sufficient gap through which the molding material can flow between the side surface of the plunger 42 and the inner surface of the injection cylinder 41. During metering, the plunger 42 retracts by the pressure of the molding material that is supplied to the injection cylinder 41, passes through the first clearance C1, and is sent to the front surface of the plunger 42. By detecting the position of the plunger 42 with an encoder (not shown), a desired amount of molding material can be metered in the injection cylinder 41. However, for metering, the plunger 42 may be actively retracted by the plunger drive device 46. After metering a predetermined amount of molding material, the plunger 42 is advanced at a predetermined speed or pressure to push out the molding material in the injection cylinder 41 to the nozzle 44.

The nozzle 44 is attached to the front surface of the injection cylinder 41, and the nozzle 44 is brought into contact with a sprue bush of the mold at least during injection. The molding material pushed out by the plunger 42 is injected from the tip of the nozzle 44 into the mold. The molding material that has entered the mold from the opening of the sprue bush is sent to the cavity through the sprue and runner. The nozzle 44 is heated to a predetermined temperature by the heater 49.

The seal cylinder 5 is a cylinder body which is provided at the rear end of the injection cylinder 41 and through which the plunger 42 is inserted. The seal cylinder 5 seals between the injection cylinder 41 and the plunger 42 to suppress leakage of the molding material. That is, the seal cylinder 5 closes the flow path to an extent that the molding material can hardly flow through, and suppresses the leakage of the molding material to the rear of the seal cylinder 5. Furthermore, the seal cylinder 5 in this embodiment slidably holds the inserted plunger. The seal cylinder 5 may be accommodated in the injection cylinder 41 and the connecting cylinder 43. The detailed configuration of the seal cylinder 5 will be described later.

The sub-guide cylinder 6 is a cylinder body which is provided on the rear side of the seal cylinder 5 and through which the plunger 42 is inserted. The sub-guide cylinder 6 slidably holds the inserted plunger. The sub-guide cylinder 6 may be accommodated in the connecting member 45. The detailed configuration of the sub-guide cylinder 6 will be described later.

The connecting cylinder 43 is a cylinder body for accommodating the seal cylinder 5 and attaching the seal cylinder 5 to the injection cylinder 41. The plunger 42 is inserted through the connecting cylinder 43, and the connecting cylinder 43 in this embodiment is not intended for sealing the molding material or supporting the plunger 42, so the gap between the inner surface of the connecting cylinder 43 and the side surface of the plunger 42 may be set sufficiently large. The connecting cylinder 43 is connected to the plunger drive device 46 via the connecting member 45. The plunger drive device 46 may be any actuator that advances and retracts the plunger 42, for example, a hydraulic cylinder or an electric cylinder. The piston of the plunger drive device 46 and the plunger 42 are connected by the coupling 47.

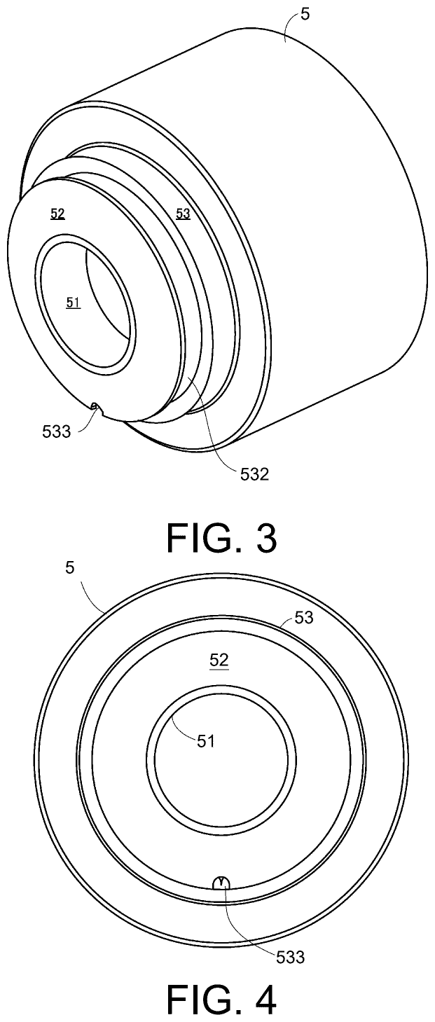

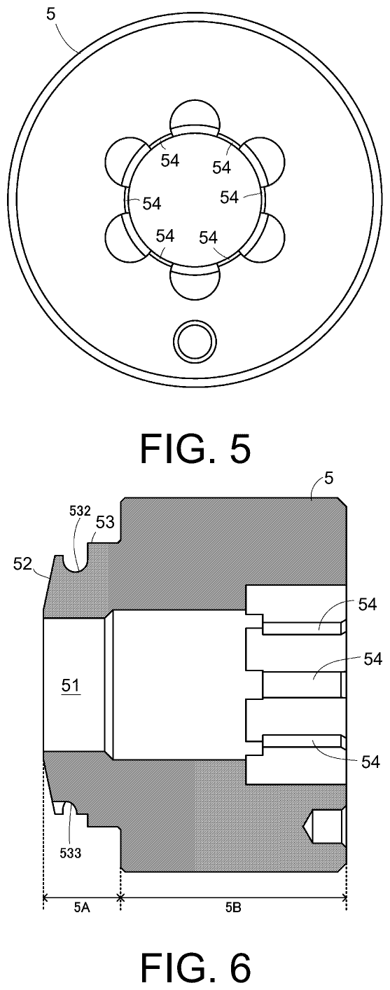

The seal cylinder 5 in this embodiment shown in FIG. 3 to FIG. 7 is configured to include a seal part 5A and a guide part 5B, and performs sealing of the molding material, and guiding and supporting of the plunger 42.

The seal part 5A seals between the injection cylinder 41 and the plunger 42 at the rear end of the injection cylinder 41. In particular, the seal part 5A in this embodiment is configured to deflect inward by the pressure of the molding material generated during dwelling, and reduce a second clearance C2. The seal part 5A is inserted through the injection cylinder 41 so that a gap is formed with the inner surface of the injection cylinder 41. The seal part 5A has a seal surface 51, a front surface 52, and an outer side surface 53.

The seal surface 51 is a part of the inner surface of the seal cylinder 5, and is a surface facing the plunger 42 and formed over the entire circumference in the circumferential direction. The second clearance C2 is formed between the seal surface 51 and the side surface of the plunger 42. The second clearance C2 is a gap smaller than the first clearance C1, and is set to a size that the molding material substantially does not flow through, within a range that does not interfere with the sliding of the plunger 42. Also, as described later, the second clearance C2 is reduced by the pressure of the molding material generated during dwelling. The size of the second clearance C2 when no pressure of the molding material is applied is, for example, about 2 μm or more and about 15 μm or less, and more preferably, about 6 μm or more and about 8.5 μm or less. The size of the second clearance C2 reduced by the dwelling may be substantially 0 μm. The seal cylinder 5 may be slightly deformed by the external pressure applied when being attached to the injection cylinder 41, and the range related to the size of the second clearance C2 mentioned above is the value after attachment.

The front surface 52 is an end surface on the front side of the seal cylinder 5. The front surface 52 forms a front surface flow path 521, which is a gap through which the molding material can flow, with the inner surface of the injection cylinder 41. In this embodiment, the front surface 52 is inclined so that at least a part thereof has a smaller diameter on the front side than on the rear side. The pressure generated by the molding material in the front surface flow path 521 during dwelling acts in a direction substantially perpendicular to the front surface 52. By inclining the front surface 52, pressure can be more suitably applied to the front surface 52 to reduce the second clearance C2. An inclination angle θ of the front surface 52, with a straight line that is horizontal to the axial direction of the plunger 42 as a reference line, is, for example, about 77° or more and about 83° or less, and more preferably, about 79° or more and about 81° or less. The inner surface of the injection cylinder 41 facing the front surface 52 may be inclined at substantially the same angle as the front surface 52.

The outer side surface 53 is an outer peripheral surface of the front part of the seal cylinder 5. The outer side surface 53 forms a side surface flow path 531, which is a gap through which the molding material can flow, with the inner surface of the injection cylinder 41. Preferably, a groove 532 is formed over the entire circumference along the circumferential direction on the outer side surface 53, and the side surface flow path 531 is configured to include the groove 532. In this case, the seal part 5A may further have a groove outlet 533 that communicates with the front surface 52 and the lower end of the groove 532, at the lower end of the groove 532. The supply flow path 412 of the injection cylinder 41 is positioned above the outer side surface 53, that is, above the groove 532. The molding material sent from the plasticization device 2 is supplied from above the groove 532 via the supply flow path 412.

In this embodiment, the flow path resistance of the front surface flow path 521 is configured to be greater than the flow path resistance of the side surface flow path 531. That is, it is configured so that the molding material flows more easily through the side surface flow path 531 than through the front surface flow path 521. For the molding material to flow more easily through the side surface flow path 531 than through the front surface flow path 521, for example, the cross-sectional area of the side surface flow path 531 is configured to be larger than the cross-sectional area of the front surface flow path 521. In addition, in this embodiment, the amount of molding material sent from the plasticization device 2 to the injection device 4 via the supply flow path 412 is configured to be greater than the amount of molding material discharged from the groove outlet 533. In order to make the discharge amount of molding material from the groove outlet 533 smaller than the supply amount of molding material, for example, the cross-sectional area of the supply flow path 412 is configured to be larger than the cross-sectional area of the groove outlet 533.

When metering begins, the molding material sent from the plasticization device 2 is supplied to above the groove 532 through the communication passage 31 of the junction 3 and the supply flow path 412 of the injection cylinder 41. Since the seal part 5A is configured so that the molding material flows more easily through the side surface flow path 531 than through the front surface flow path 521, first, most of the molding material is sent downward along the groove 532 and discharged forward from the groove outlet 533. The molding material discharged from the groove outlet 533 passes through the front surface flow path 521 near the groove outlet 533, and is sent to the first clearance C1. Here, since the amount of molding material being supplied exceeds the amount discharged from the groove outlet 533, gradually the molding material is also discharged forward from the front surface flow path 521 other than near the groove outlet 533, and sent to the first clearance C1. Thus, the molding material passes through the first clearance C1 and is sent to the front of the plunger 42. The molding material sent to the front of the plunger 42 is stored in the metering chamber 411 while pushing down the plunger 42.

If the molding material stagnates and is heated for a long period of time, carbonization or deterioration may occur. In this embodiment, the injection device 4 is configured with a so-called first in, first out flow path, so the molding material is less likely to stagnate. Specifically, by configuring the molding material to be supplied from the rear side of the injection cylinder 41 and to flow through the front side, stagnation in the first clearance C1, the front surface flow path 521, and the side surface flow path 531 is suppressed. In addition, by providing the groove outlet 533, stagnation in the lower part away from the supply flow path 412 is suitably suppressed. In particular, since the flow path is configured to discharge the molding material from the entire front surface flow path 521, not just around the groove outlet 533, stagnation in areas other than the lower part is suitably suppressed as well.

When the plunger 42 reaches a desired position, metering is determined to be completed. After metering is completed, the flow path between the plasticization device 2 and the injection device 4 is blocked by the backflow prevention device 25. Then, the plunger 42 advances to perform injection and dwelling. During dwelling, much greater pressure than during metering or injection is applied to the molding material. The pressure of the molding material that is present in the front surface flow path 521 and the side surface flow path 531 is transmitted to the front surface 52 and the outer side surface 53, causing the seal part 5A to deflect inward. As a result, the second clearance C2, which is the gap between the seal surface 51 and the plunger 42, is reduced, so the flow of the molding material into the second clearance C2 and the leakage of the molding material to the rear can be suppressed. At this time, the second clearance C2 may be reduced to substantially 0 μm to bring the seal surface 51 and the plunger 42 into contact with each other. The pressure of the molding material (that is, the dwelling pressure) and the deflection amount of the seal part 5A have an approximately proportional relationship, and in this embodiment, when the pressure of the molding material reaches about 35 MPa to about 55 MPa, the second clearance C2 becomes substantially 0 μm. Since the plunger 42 hardly moves during dwelling, galling is unlikely to occur even if the second clearance C2 is reduced. When the dwelling is completed, the deflection of the seal part 5A returns to the original state, and the size of the second clearance C2 also returns to the original state. According to the configuration of this embodiment, since the second clearance C2 is automatically reduced by the pressure of the molding material during dwelling, no special control is required for sealing, making it easier to achieve sealing. Additionally, since the second clearance C2 returns to the original size when dwelling is completed, there is no hindrance to the sliding of the plunger 42 in the next metering and injection.

In order to configure the seal part 5A to be capable of deflecting, the seal cylinder 5 is preferably made of a material with high strength and toughness. For example, cold work tool steel QCM8 (manufactured by Sanyo Special Steel Co., Ltd.) can be adopted as a material for the seal cylinder 5.

The guide part 5B holds the inserted plunger 42 slidably on the rear side of the seal part 5A. The guide part 5B is inserted through the injection cylinder 41 and the connecting cylinder 43 so that the outer periphery is in contact with the inner surface of the injection cylinder 41 and the inner surface of the connecting cylinder 43. This causes the rear end of the injection cylinder 41 to be closed. The guide part 5B in this embodiment has six guide surfaces 54 arranged uniformly in the circumferential direction, and supports the plunger 42 on the guide surfaces 54. However, the positions and the number of the guide surfaces 54 are not limited thereto. The size of the clearance between the guide surfaces 54 and the plunger 42 is preferably small enough so as not to interfere with the sliding of the plunger 42. The size of this clearance is, for example, about 2.5 μm or more and about 4 μm or less. The guide surfaces 54 suppress the inclination of the plunger 42 and suppress contact between the plunger 42 and the injection cylinder 41.

The gap between the inner surface of the seal cylinder 5 excluding the seal surface 51 and the guide surfaces 54 and the side surface of the plunger 42 may be set sufficiently large.

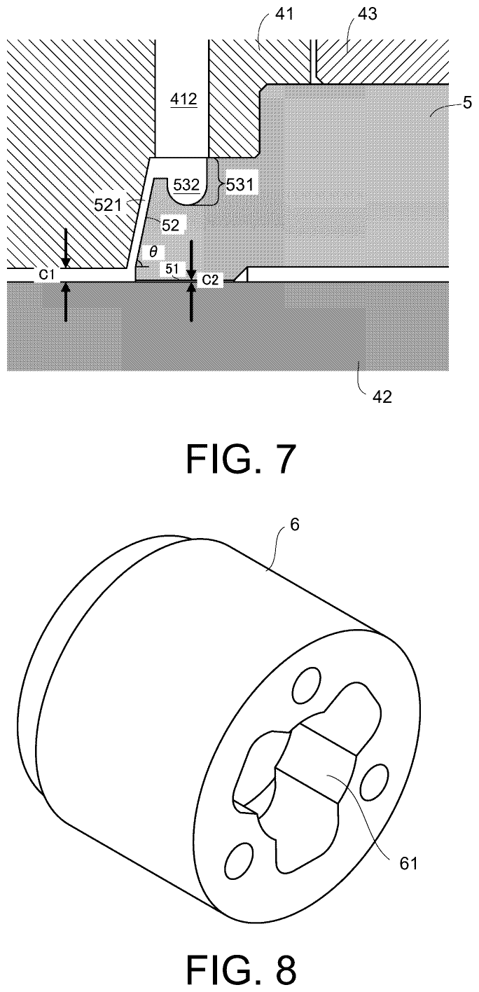

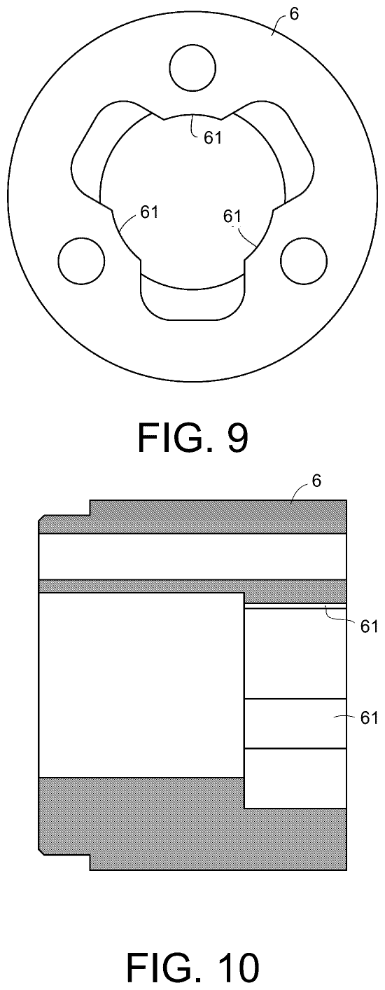

The sub-guide cylinder 6 in this embodiment shown in FIG. 8 to FIG. 10 guides and supports the plunger 42. The sub-guide cylinder 6 holds the inserted plunger 42 slidably on the rear side of the seal cylinder 5. In order to support the plunger 42 more stably, the sub-guide cylinder 6 is preferably provided at a certain distance from the seal cylinder 5. The sub-guide cylinder 6 in this embodiment has three guide surfaces 61 arranged uniformly in the circumferential direction, and supports the plunger 42 on the guide surfaces 61. However, the positions and the number of the guide surfaces 61 are not limited thereto. The size of the clearance between the guide surfaces 61 and the plunger 42 is preferably small enough so as not to interfere with the sliding of the plunger 42. The size of this clearance is, for example, about 5 μm or more and about 7 μm or less. The guide surfaces 61 suppress the inclination of the plunger 42 and suppress contact between the plunger 42 and the injection cylinder 41. The gap between the inner surface of the sub-guide cylinder 6 excluding the guide surfaces 61 and the side surface of the plunger 42 may be set sufficiently large.

The disclosure is not limited to the configurations of the embodiments shown in the figures, as already specifically shown in several examples, and various modifications or applications are possible within the scope that does not deviate from the technical concept of the disclosure.

What is claimed is:

1. An injection molding machine, comprising:
a plasticization device to which a molding material comprising at least resin is supplied and which plasticizes the molding material;
an injection device which meters and injects the molding material sent from the plasticization device and performs dwelling to apply a predetermined pressure to the molding material for a predetermined time; and
a junction which connects the plasticization device and the injection device,
wherein the plasticization device comprises:
a plasticization cylinder to which the molding material is supplied; and
a screw which is rotatably provided in the plasticization cylinder,
wherein the injection device comprises:
an injection cylinder to which the molding material is sent from the plasticization cylinder;
a plunger which is provided to be advanceable and retractable in the injection cylinder; and
a seal cylinder which is provided at a rear end of the injection cylinder and through which the plunger is inserted,
wherein the seal cylinder comprises a seal part which seals between the injection cylinder and the plunger,
wherein the seal part comprises:
a seal surface which faces the plunger;
a front surface which forms a front surface flow path that is a gap which allows the molding material to flow through between the injection cylinder and the front surface; and
an outer side surface which forms a side surface flow path that is a gap which allows the molding material to flow through between the injection cylinder and the outer side surface,
wherein a first clearance that is a gap which allows the molding material to flow through is provided between the injection cylinder and a side surface of the plunger, and
a second clearance that is a gap smaller than the first clearance and is reducible by pressure of the molding material generated during dwelling is provided between the seal surface and the side surface of the plunger.

2. The injection molding machine according to claim 1, wherein the side surface flow path is configured to comprise a groove formed along a circumferential direction of the outer side surface.

3. The injection molding machine according to claim 2, wherein the molding material sent from the plasticization device is supplied from above the groove.

4. The injection molding machine according to claim 2, wherein the seal part further comprises a groove outlet which communicates with the front surface and a lower end of the groove.

5. The injection molding machine according to claim 4, wherein a flow path resistance of the front surface flow path is greater than a flow path resistance of the side surface flow path, and
an amount of the molding material sent from the plasticization device to the injection device is greater than an amount of the molding material discharged from the groove outlet.

6. The injection molding machine according to claim 1, wherein the front surface is inclined so that at least a part of the front surface has a smaller diameter on a front side than on a rear side.

7. The injection molding machine according to claim 6, wherein an inclination angle of the front surface, with a straight line that is horizontal to an axial direction of the plunger as a reference line, is 77° or more and 83° or less.

8. The injection molding machine according to claim 1, wherein the seal cylinder further comprises a guide part which slidably holds the plunger that has been inserted on a rear side of the seal part.

9. The injection molding machine according to claim 1, further comprising a sub-guide cylinder which is provided on a rear side of the seal cylinder and slidably holds the plunger that has been inserted.

10. The injection molding machine according to claim 1, wherein a size of the first clearance is 0.5 mm or more and 1.5 mm or less.

11. The injection molding machine according to claim 1, wherein a size of the second clearance with no pressure of the molding material applied is 2 μm or more and 15 μm or less.

12. The injection molding machine according to claim 1, wherein the molding material comprises the resin and a filler.

13. The injection molding machine according to claim 12, wherein the filler comprises metal.

14. The injection molding machine according to claim 1, wherein the molding material is a material which generates corrosive gas during plasticization.
